(19) United States
(12) Patent Application Publication
(10) Pub. No.: US 2023/0374848 A1
(43) Pub. Date: Nov. 23, 2023

(54) DOOR WITH COMPRESSIBLE CORRUGATED FIBERBOARD CORE

(71) Applicant: JELD-WEN, Inc., Charlotte, NC (US)

(72) Inventors: Richard Hartzog, Clayton, AL (US); Pramod Kumar, Peachtree City, GA (US)

(73) Assignee: JELD-WEN, Inc., Charlotte, NC (US)

(21) Appl. No.: 18/260,266

(22) PCT Filed: Jan. 7, 2022
(86) PCT No.: PCT/US2022/070084

§ 371 Date: Jul. 3, 2023

Related U.S. Application Data
(60) Provisional application No. 63/134,959, filed on Jan. 8, 2021.

(51) Int. Cl. E06B 3/70

(52) U.S. Cl. CPC E06B 3/7015; E06B 3/7001; E06B 2003/7019; E06B 2003/7053

(57) ABSTRACT

A door includes a first skin, a second skin, and a core. The core is disposed between the first skin and the second skin in a thickness direction of the door and spans between the first and second skins. The core includes a corrugated medium that is fluted with fluting running back and forth in the thickness direction between the first skin and the second skin as the corrugated medium spans between the first and second skins. The door also includes a compressed section where at least one of the first skin and the second skin is compressed into the core toward the other of the first skin and the second skin in the thickness direction.

### CROSS REFERENCE TO RELATED APPLICATION

This application claims priority to U.S. Provisional Patent Application No. 63/134,959, filed Jan. 8, 2021, the entire disclosure of which is incorporated by reference.

### TECHNICAL FIELD

The field of the present disclosure relates to fenestration systems and more particularly to doors assembled from a pair of door skins (aka door facings) attached to an internal perimeter frame surrounding a central core, and to cores for such doors and methods of manufacturing such doors.

### BACKGROUND

A known method of assembling doors involves applying adhesive to an inside surface of two door skins; laying up a door assembly by stacking an internal frame and lightweight core material between the door skins; and pressing the door assembly to bring the adhesive into contact with the frame. Various core materials have been proposed for such doors. Some such door skins include recessed panel regions or inwardly-contoured channels that simulate the sticking regions of a traditional solid wood paneled door.

U.S. Pat. No. 10,556,413, which is incorporated herein by reference, describes systems and methods for pressing a door assembly in a die that includes raised sections supporting recessed panel portions of a door skin during the pressing operation to assist with crushing portions of a compressible core of the door assembly underlying the recessed panel portion of the door skin. This patent describes a core made of an expanded paper honeycomb material having a compressive strength in the range of 1.0 kg force per square centimeter (kgf/cm²) to about 15 kgf/cm². It also suggests the use of other compressible materials for the core, such as expanded plastic film honeycomb, corrugated cardboard, and low density foam board, but provides no further details of such materials.

Preferably, these doors have high strength and are robust while also meeting weight, dimensional, sound insulation, heat transfer, and/or other requirements. Moreover, these doors are preferably made in a highly efficient and repeatable manufacturing process.

Thus, it is desirable to provide robust and strong door configurations that can be manufactured in highly efficient and repeatable processes. Other aspects and advantages of the present disclosure will be apparent from the following detailed description of preferred embodiments, which proceeds with reference to the accompanying drawings.

### BRIEF SUMMARY

This is solved by the subject-matter of the independent claims. Further embodiments are included in the dependent claims.

In one embodiment, a door is disclosed that includes a first skin, a second skin, and a core. The core is disposed between the first skin and the second skin in a thickness direction of the door and spans between the first and second skins. The core includes a corrugated medium that is fluted with fluting running back and forth in the thickness direction between the first skin and the second skin as the corrugated medium spans between the first and second skins. The door also includes a compressed section where at least one of the first skin and the second skin is compressed into the core toward the other of the first skin and the second skin in the thickness direction.

In another embodiment, a method of manufacturing a door is disclosed. The method includes providing a first skin and a second skin of the door. The method also includes disposing a core between the first skin and the second skin in a thickness direction of the door with the core spanning between the first and second skins. The core includes a corrugated medium that is fluted with fluting running back and forth in the thickness direction between the first skin and the second skin as the corrugated medium spans between the first and second skins. The method also includes forming a compressed section where at least one of the first skin and the second skin is compressed into the core toward the other of the first skin and the second skin in the thickness direction.

In a further embodiment, a door is disclosed that includes a first skin, a second skin, and a frame that is disposed between the first skin and the second skin. The door further includes a core that is disposed within the frame and between the first skin and the second skin in a thickness direction of the door. The core spans across the door between the first and second skins. The core includes a corrugated medium that is fluted with fluting running back and forth in the thickness direction between the first skin and the second skin as the corrugated medium spans between the first and second skins. The door further includes a compressed section where at least one of the first skin and the second skin is compressed into the core toward the other of the first skin and the second skin in the thickness direction. The core includes a plurality of walls, and one of the plurality of walls includes the corrugated medium that is supported by at least one linerboard. Another of the plurality of walls includes another corrugated medium that is fluted with fluting running back and forth in the thickness direction between the first skin and the second skin. The other corrugated medium is supported by another linerboard. The corrugated medium and the other corrugated medium have different periodicity.

### BRIEF DESCRIPTION OF THE DRAWINGS

The present disclosure will hereinafter be described in conjunction with the following drawing figures, wherein like numerals denote like elements, and wherein:

FIG. 1 is a pictorial or plan view of a door according to a preferred example embodiment of the present disclosure.

FIG. 2 is a vertical cross-section view of the door of FIG. 1 taken along line 2-2 included in FIG. 1.

FIG. 3 is an enlarged vertical cross-section detail view taken from the area indicated in FIG. 2, illustrating how door skins of the door transition to recessed panel regions compressing a triple-wall corrugated fiberboard core therebetween.

FIG. 4 is a horizontal cross-section view of the door of FIG. 1 taken along line 4-4 in FIG. 1.

FIG. 5 is an enlarged horizontal cross-section detail taken from the area indicated in FIG. 4.

FIG. 6 is an exploded view of the door of FIG. 1.

FIG. 7 is a schematic view showing fluting of the corrugated fiberboard core of FIGS. 1 and 2.

FIG. 8 is a plan view of a plurality of doors having different panel layouts.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

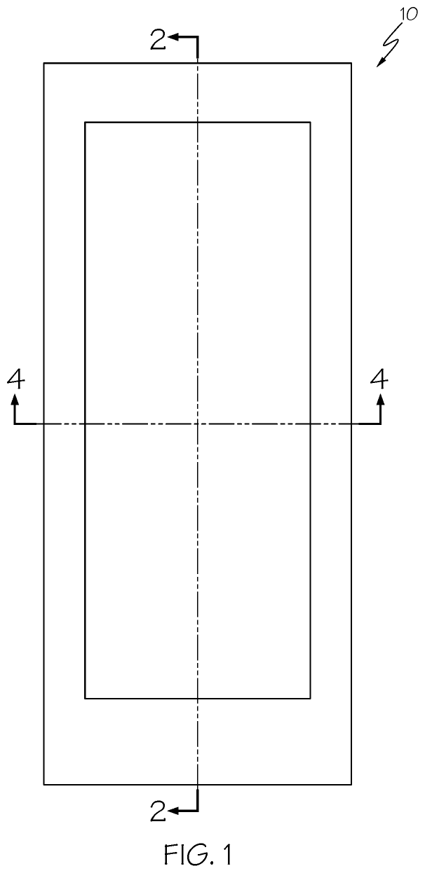

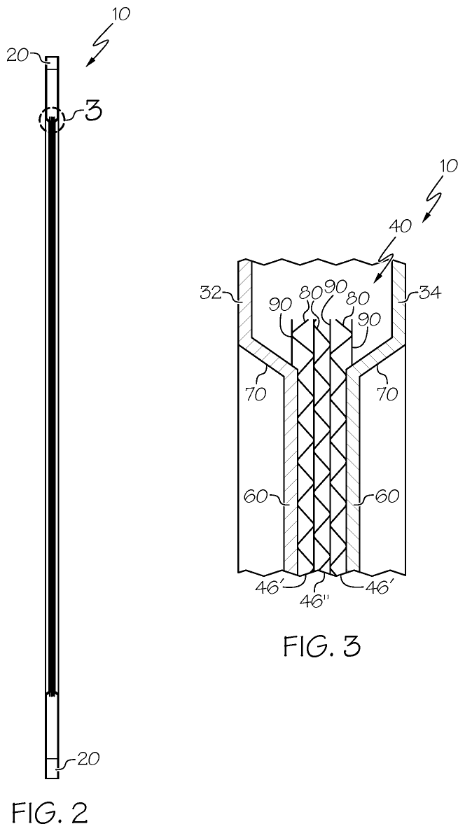

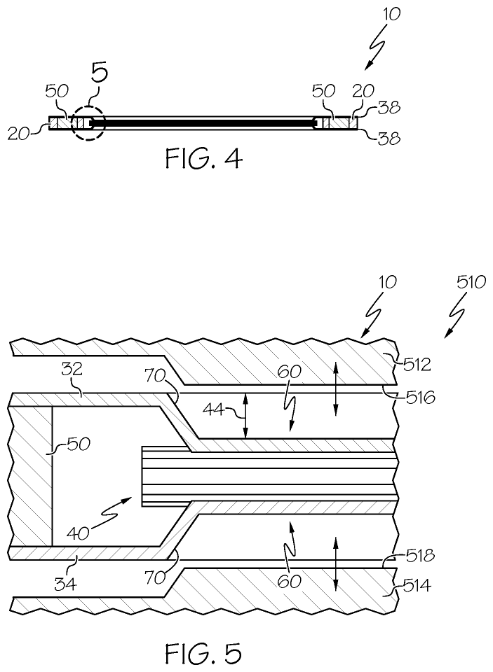

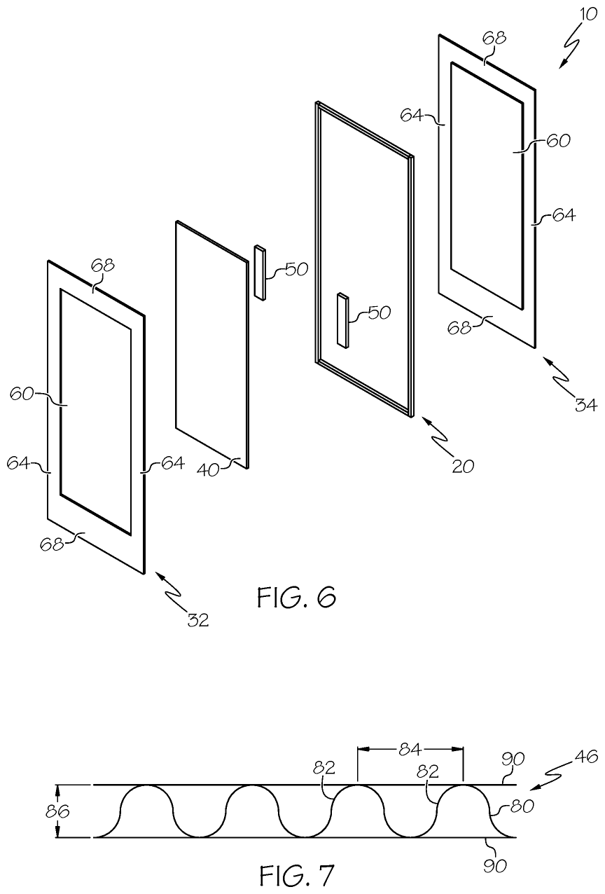

With reference to FIGS. 1 and 6, a door 10 includes an internal frame 20 that extends around a perimeter of door 10 and is overlaid with a first (or front) door skin 32 and a second (or rear) door skin 34. The first and second door skins 32, 34 and frame 20 define a cavity of the door 10 within which a core 40 is positioned. Core 40 may provide structural support, insulate against sound or heat transfer, and/or serve other functions in the door assembly. One or more lock blocks 50 may be positioned along the vertical portions of the internal frame 20 to provide structural support for a doorknob, latch, and/or lock of the door (not illustrated). First and second door skins 32, 34 are preferably molded, for example of a fiberboard material, a fiberglass material, or a composite material. First and second door skins 32, 34 may be adhesively attached to internal frame 20 via a layer of adhesive 38 (FIG. 4), which may be applied to the frame 20 or to perimeter regions of inner surfaces of the door skins 32, 34 before assembling the components and pressing them together.

Each of the door skins 32, 34 preferably includes at least one recessed portion. In the embodiment illustrated, door skins 32, 34 includes a single recessed flat panel portion 60 (i.e., a compressed section) that is bordered by a pair of vertically-extending simulated stile regions 64 and a pair of simulated header and footer rail regions 68 extending horizontally between the stile regions 64. The stile regions 64 and rail regions 68 of each door skin 32, 34 lies in a first plane, and the recessed panel portion 60 lies in a second plane that is parallel but spaced apart from the first plane, thereby defining a depth 44 of the recess. In other embodiments, multiple recessed panels may be utilized, as illustrated in the various other styles of doors 110, 210, 310, 410, 510 illustrated in FIG. 8. Additionally, in some embodiments (not illustrated), the panel(s) may not be recessed, but may instead lie in the same first plane (i.e., in a common plane) as stile and rail regions 64, 68, wherein each panel is bordered by a sticking region that marks a transition between the panel(s) and the stile and rail regions. At least some of the sticking region may be recessed inwardly from the first plane of the stiles, rails and panel(s).

FIG. 3 and FIG. 5 illustrate a transition between the stile and rail regions 64, 68 and the recessed panel portion 60. The transition region is known in the art as sticking 70. The sticking 70 of the embodiment illustrated is a simple inclined section connecting the stile region 64 or rail region 68 to the panel portion 60. Sticking 70 may desirably be as close to perpendicular to the first and second planes as is possible to manufacture without compromising the product integrity or manufacturability, so as to simulate a conventional solid stile and rail door. In other embodiments, the sticking may be contoured with complex curved profiles for a more detailed or traditional appearance. For example, in embodiments having panels that are not recessed (not illustrated), the sticking 70 may be contoured so that at least some of the sticking 70 is recessed inwardly from the first plane of the stiles, rails and panel(s).

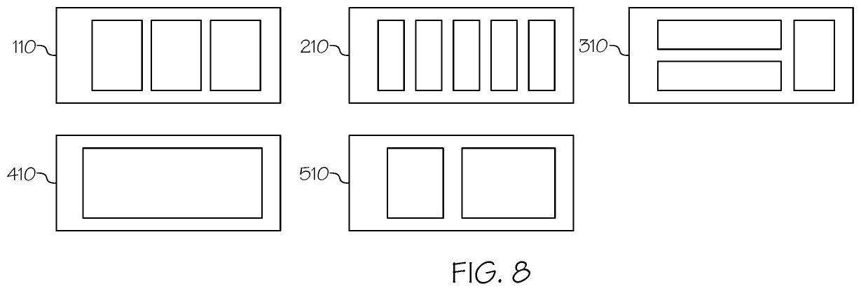

Turning now particularly to FIG. 3, core 40 may comprise a compressible corrugated fiberboard material made of a plurality of layers. The core 40 may include at least one wall 46 (FIG. 7) of corrugated fiberboard material. The corrugated fiberboard material may be the kind colloquially known as corrugated cardboard, and best known for its use in cardboard boxes and other corrugated fiberboard packaging. The layers of material in the core 40 may be made of paperboard, cardboard, containerboard, or other fiberboard materials.

As shown in FIG. 7, the wall 46 may include a corrugated medium 80 that is supported and attached to at least one layer of linerboard 90. In some embodiments, the corrugated medium 80 may be attached to, supported, and sandwiched between two sheets of linerboard 90.

The linerboard 90 may be individual flat and smooth sheets of fiberboard material. The corrugated medium 80, however, may be fluted so as to define a pattern of flutes 82 (i.e., waves, corrugations, etc.) that rise and fall relative to the linerboard 90. The flutes 82 of the corrugated medium 80 may, thus, alternate back and forth in the thickness direction between opposite layers of the linerboard 90 as shown in FIG. 7. In some embodiments, the corrugated medium 80 may include rounded, arcuate, semi-circular flutes 82. However, the flutes 82 may have a sawtooth or other profile in some embodiments without departing from the scope of the present disclosure. The flutes 82 may be arranged at a consistent flute distance 84 measured from peak-to-peak. The flutes 82 may also have a consistent amplitude or wall thickness 86 measured in the thickness direction from peak-to-nadir of the adjacent flutes 82.

As seen, for example, in the embodiment illustrated in FIG. 3, the core 40 may comprise a plurality of walls 46, and the walls 46 may be layered over each other. In some embodiments, each wall 46 of core 40 includes a corrugated medium 80 interposed between a pair of linerboard layers 90, with adjacent walls sharing an internal linerboard layer 90. The outer surfaces of core 40 may be coated with glue or adhesive 38 before assembly into door 10, to facilitate bonding of door skins 32, 34 to core 40, thereby enhancing structural integrity.

There may be at least three walls 46 in the core 40. For example, as shown in FIG. 3, the core 40 may comprise three walls 46 (i.e., may comprise a triple-wall corrugated fiberboard material). The three walls 46 of the core 40 may include three layers of corrugated medium 80 interposed between and glued to four layers of linerboard 90 as shown in FIG. 3.

The corrugations or flutes of the corrugated medium 80 may define a fluting direction (i.e., a longitudinal direction of the flutes of the corrugated medium 80). In the embodiment illustrated, the fluting of the core 40 runs horizontally with each flute extending substantially parallel to rail regions 68. However, in another embodiment, the fluting may be arranged to run vertically so that the flutes are extending parallel to stile regions 64. The fluting direction may be chosen, for example, to provide structural support and rigidity, for resisting bending and/other loads, to support the weight of the door, to align along a particular loading direction, etc. The fluting direction may also be chosen to increase manufacturability. For example, the fluting direction may be chosen to improve the flatness of core 40 in its longest dimension and/or to reduce the tendency of core 40 to curl when passed between the rollers of a glue spreader machine.

The corrugated medium 80 may also define a corrugation periodicity, which may be measured in “flutes per unit of length” measured along the same direction as the flute distance 84. As mentioned above, the core 40 may be compressed in at least some areas of the door 10 during manufacture. Thus, the corrugation periodicity of the corrugated medium 80 may be chosen to provide certain characteristics during compression of the skins 32, 34 into the core 40.

For example, to allow sufficient compressibility, at least one wall 46 of the multi-wall core 40 preferably has a corrugation periodicity coarser than about forty-two (42) flutes per foot (i.e., forty-two or fewer flutes per foot; or 137.8 or fewer flutes per meter) and a wall thickness 86 of greater than about 5/32 inch (about 4 mm). Accordingly, at least one wall 46 may be characteristic of a so-called “C-flute” corrugation, which has a nominal periodicity of 39+/−3 flutes per foot (about 128+/−10 flutes per meter). Moreover, in some embodiments, at least one wall 46 of core 40 has a corrugation periodicity coarser than about thirty-six (36) flutes per foot (i.e., thirty-six (36) or fewer flutes per foot; or one hundred eighteen (118) or fewer flutes per meter) and a wall thickness of greater than about 3/16 inch (about 4.7 mm). Accordingly, at least one wall 46 may be characteristic of a so-called “A-flute” configuration, which has a nominal periodicity of 33+/−3 flutes per foot (108+/−10 flutes per meter).

At least two adjacent walls 46 of the multi-wall corrugated fiberboard core 40 may have different types of fluting having different periodicity. As shown in FIG. 3, there may be a first wall 46′ having a first periodicity and a neighboring second wall 46″ having a different second periodicity layered over each other. In addition, the second wall 46″ may be sandwiched on both sides by respective first walls 46′ having the first periodicity. Accordingly, in one embodiment, core 40 is made of CAA corrugated fiberboard, having one layer of C-flute corrugated medium 80 (of the second wall 46″) and two layers of A-flute corrugated medium 80 (of the first walls 46′) on the opposite sides. The corrugated medium 80 of the different walls 46 may be interposed between respective linerboard layers 90 as discussed above. Thus, the arrangement of the different walls 46 and the stack up and staggered arrangement of the flutes 82 through the thickness of the core 40 may provide a suitable overall thickness and compressibility of core 40.

In another embodiment, core 40 is made of CCA corrugated fiberboard, having two layers of C-flute corrugated medium 80 and one layer of A-flute corrugated medium 80 interposed between linerboard layers 90. CCA-fluted corrugated fiberboard may be selected for its thinner profile, for example when a gap between the closest points on door skins 32, 34 is smaller. In some embodiments (not shown) a thinner core of two-wall AA or CA or CC corrugated fiberboard may be utilized, while in other embodiments a thicker core of four- or five-walled corrugated fiberboard may be utilized.

In some embodiments, two or more of the walls 46 of core 40 may have the same or similar periodicity or fluting type, and adjacent walls may have their flutes aligned and in-phase to improve compressibility of the core 40. In other embodiments two or more walls may be positioned with their similarly-fluted mediums shifted half of a flute (½ a period) so that adjacent flutes are 180-degrees out of phase. This latter arrangement is shown, for example, in FIG. 3 where the outermost flutes are 180-degree-out-of-phase from each other. In still other embodiments, adjacent walls may be positioned with their fluted mediums shifted ¼ of a flute (¼ of a period) so that adjacent flutes are 90-degrees out of phase. Desirably, the fluting of the various corrugated mediums of 2-walled or 3-walled corrugated fiberboard are oriented in the same direction to improve compressibility. However, in other embodiments requiring less compressibility or greater strength or dimensional stability, one of the walls 46 may be oriented transversely of the other medium layer(s) 90, for example, rotated 90-degrees so as to run perpendicular to the fluting of the other medium layer(s) 80.

A press 510 is illustrated schematically in FIG. 5 to illustrate embodiments of a manufacturing system and manufacturing process for the door 10. The press 510 may include a first die 512 and a second die 514 that may actuate toward each other to compress a stack up that includes the first door skin 32, the core 40, and the second door skin 34. The first die 512 may include a contoured first die face 516, and the second die 514 may include a contoured second die face 518 that are the inverse of the flat panel portions 60 and sticking 70 to be formed on the door 10. The first door skin 32, core 40, and second door skin 34 stack up may be placed between the die faces 516, 518. The frame 20, the lock blocks 50, and/or other components may also be included between the first and second door skins 32, 34.

Then, the first and second dies 512, 514 may actuate toward the stack up to compress and mold the recessed flat panel portion 60 into the door while also attaching the first door skin 32 to the core 40, attaching the second door skin 34 to the other side of the core 40, and attaching the skins 32, 34 to the frame 20 and lock blocks 50. In particular, compression applied by the dies 512, 514 may form the recessed flat panel portion 60 (i.e., the compressed section) of the door 10 wherein the first and second skins 32, 34 are compressed into the core 40 in the thickness direction. As represented in FIGS. 3-6, the margins of the core 40 may be spaced apart at a distance from the frame 20 and the lock blocks 50 when compressed.

In some embodiments, the core 40 may compressed in the range of about 5% to about 30% during assembly (e.g., to a thickness that is about 95% to 70% of its original thickness) in the region of recessed panel portions 60 and/or sticking 70 when less than about 70 pounds force per square inch (482 kN/m2) is applied to the outer sides of door skins 32, 34. In other embodiments, core 40 may be compressed in the range of 5% to 25%, or 10% to 30%, or 5% to 20%, or 10% to 25%, or 10% to 20%. Such compressibility characteristics may facilitate door assembly, improve structural integrity and bonding of the components of door 10, and inhibit bowing or cracking of door skins 32, 34 or pillowing of panel(s) 60. Doors made according to the present disclosure may be assembled and pressed using the methods and systems described in Patent No. U.S. Pat. No. 10,556,413, for example, to thereby further improve door quality.

The first and second dies 512, 514 and/or other dies of the press 510 may be configured for attaching the skins 32, 34 to the frame 20 and/or to the lock block 50. Once formed, the dies 512, 514 may be withdrawn and the door 10 may be removed from the press 510.

The multi-walled corrugated fiberboard core 40 may help to stabilize the door 10 and provide structural integrity that resists warping, twisting, and other deformation of the door 10 or door skins 32, 34, and that inhibits the effects of humidity and temperature changes that may otherwise impart deformation to the door 10. At the same time, corrugated fiberboard core 40 adds little cost to the door relative to a hollow door without a core. The corrugated fiberboard core 40 also has the advantage of being lighter than solid fiberboard cores and some foam core materials, which reduces shipping costs and facilitates speed and ease of installation, particularly in new construction applications.

Doors are preferably assembled at room temperature or ambient temperature above 65° F., or in the range of about 65° F. to 90° F., and at a relative humidity below about 55% RH, or preferably in the range of 15-55% RH, to achieve desired compressibility/deformability of the fiberboard core 40.

Corrugated fiberboard core 40 is preferably made up of recycled 23 #paper, but may alternatively be assembled from various papers, such as, virgin kraft, test 2, test 3, and others. The paper may be selected according to its impact on compressibility of the core 40.

Furthermore, the following examples are provided:

In an example, a door includes a first skin, a second skin, and a core. The core is disposed between the first skin and the second skin in a thickness direction of the door and spans between the first and second skins. The core includes a corrugated medium that is fluted with fluting running back and forth in the thickness direction between the first skin and the second skin as the corrugated medium spans between the first and second skins. The door also includes a compressed section where at least one of the first skin and the second skin is compressed into the core toward the other of the first skin and the second skin in the thickness direction.

As an option, the door further includes a vertical rail region and a horizontal stile region, wherein the fluting extends longitudinally and substantially parallel to one of the vertical rail region and the horizontal stile region.

As an additional option, the fluting extends longitudinally and substantially parallel to horizontal stile region.

As an option, the core includes fiberboard materials.

As an option, the core includes a plurality of walls, one of the plurality of walls including the corrugated medium that is supported by at least one linerboard, and another of the plurality of walls including another corrugated medium that is fluted with fluting running back and forth in the thickness direction between the first skin and the second skin, the other corrugated medium supported by another linerboard.

As an option, the one of the plurality of walls and the other of the plurality of walls share a common linerboard.

In an additional option, the corrugated medium and the other corrugated medium have different periodicity.

In a further option, the corrugated medium and the other corrugated medium are arranged out-of-phase.

In another option, the corrugated medium has arcuate fluting.

In another example, a method of manufacturing a door includes providing a first skin and a second skin of the door. The method also includes disposing a core between the first skin and the second skin in a thickness direction of the door with the core spanning between the first and second skins. The core includes a corrugated medium that is fluted with fluting running back and forth in the thickness direction between the first skin and the second skin as the corrugated medium spans between the first and second skins. The method also includes forming a compressed section where at least one of the first skin and the second skin is compressed into the core toward the other of the first skin and the second skin in the thickness direction.

As an option, forming the compressed section includes disposing the core, the first skin, and the second skin between a first die and a second die. Also, the method includes pressing the first die toward the second die to form the compressed section.

In another option, the method includes adhesively attaching the first skin, the core, and the second skin.

As an option, the method includes forming a vertical rail region and a horizontal stile region of the door. The fluting extends longitudinally and substantially parallel to one of the vertical rail region and the horizontal stile region.

In another option, the fluting extends longitudinally and substantially parallel to horizontal stile region.

Furthermore, in an option, the core includes fiberboard materials.

In an option, the core includes a plurality of walls, one of the plurality of walls including the corrugated medium that is supported by at least one linerboard, and another of the plurality of walls including another corrugated medium that is fluted with fluting running back and forth in the thickness direction between the first skin and the second skin. The other corrugated medium is supported by another linerboard.

In another option, the one of the plurality of walls and the other of the plurality of walls share a common linerboard.

Furthermore, in an option, the corrugated medium and the other corrugated medium have different periodicity.

Moreover, in an option, the corrugated medium and the other corrugated medium are arranged out-of-phase.

In a further example, a door includes a first skin, a second skin, and a frame that is disposed between the first skin and the second skin. The door further includes a core that is disposed within the frame and between the first skin and the second skin in a thickness direction of the door. The core spans across the door between the first and second skins. The core includes a corrugated medium that is fluted with fluting running back and forth in the thickness direction between the first skin and the second skin as the corrugated medium spans between the first and second skins. The door further includes a compressed section where at least one of the first skin and the second skin is compressed into the core toward the other of the first skin and the second skin in the thickness direction. The core includes a plurality of walls, and one of the plurality of walls includes the corrugated medium that is supported by at least one linerboard. Another of the plurality of walls includes another corrugated medium that is fluted with fluting running back and forth in the thickness direction between the first skin and the second skin. The other corrugated medium is supported by another linerboard. The corrugated medium and the other corrugated medium have different periodicity.

It will be obvious to those having skill in the art that many changes may be made to the details of the above-described embodiments without departing from the underlying principles of the invention. The scope of the present invention should, therefore, be determined only by the claims. While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It is understood that various changes may be made in the function and arrangement of elements described in an exemplary embodiment without departing from the scope of the present disclosure as set forth in the appended claims.

What is claimed is:

1. A door comprising:
a first skin;
a second skin;
a core that is disposed between the first skin and the second skin in a thickness direction of the door and that spans between the first and second skins, the core including a corrugated medium that is fluted with fluting running back and forth in the thickness direction between the first skin and the second skin as the corrugated medium spans between the first and second skins; and
a compressed section where at least one of the first skin and the second skin is compressed into the core toward the other of the first skin and the second skin in the thickness direction.

2. The door of claim 1, further comprising a vertical rail region and a horizontal stile region, wherein the fluting extends longitudinally and substantially parallel to one of the vertical rail region and the horizontal stile region.

3. The door of claim 2, wherein the fluting extends longitudinally and substantially parallel to horizontal stile region.

4. The door of claim 1, wherein the core includes fiberboard materials.

5. The door of claim 1, wherein the core includes a plurality of walls, one of the plurality of walls including the corrugated medium that is supported by at least one linerboard, and another of the plurality of walls including another corrugated medium that is fluted with fluting running back and forth in the thickness direction between the first skin and the second skin, the other corrugated medium supported by another linerboard.

6. The door of claim 5, wherein the one of the plurality of walls and the other of the plurality of walls share a common linerboard.

7. The door of claim 5, wherein the corrugated medium and the other corrugated medium have different periodicity.

8. The door of claim 5, wherein the corrugated medium and the other corrugated medium are arranged out-of-phase.

9. The door of claim 1, wherein the corrugated medium has arcuate fluting.

10. A method of manufacturing a door comprising:
providing a first skin and a second skin of the door;
disposing a core between the first skin and the second skin in a thickness direction of the door with the core spanning between the first and second skins, the core including a corrugated medium that is fluted with fluting running back and forth in the thickness direction between the first skin and the second skin as the corrugated medium spans between the first and second skins; and
forming a compressed section where at least one of the first skin and the second skin is compressed into the core toward the other of the first skin and the second skin in the thickness direction.

11. The method of claim 10, wherein forming the compressed section includes disposing the core, the first skin, and the second skin between a first die and a second die; and
further comprising pressing the first die toward the second die to form the compressed section.

12. The method of claim 11, further comprising adhesively attaching the first skin, the core, and the second skin.

13. The method of claim 10, further comprising forming a vertical rail region and a horizontal stile region of the door, and wherein the fluting extends longitudinally and substantially parallel to one of the vertical rail region and the horizontal stile region.

14. The method of claim 13, wherein the fluting extends longitudinally and substantially parallel to horizontal stile region.

15. The method of claim 10, wherein the core includes fiberboard materials.

16. The method of claim 10, wherein the core includes a plurality of walls, one of the plurality of walls including the corrugated medium that is supported by at least one linerboard, and another of the plurality of walls including another corrugated medium that is fluted with fluting running back and forth in the thickness direction between the first skin and the second skin, the other corrugated medium supported by another linerboard.

17. The method of claim 16, wherein the one of the plurality of walls and the other of the plurality of walls share a common linerboard.

18. The method of claim 16, wherein the corrugated medium and the other corrugated medium have different periodicity.

19. The method of claim 16, wherein the corrugated medium and the other corrugated medium are arranged out-of-phase.

20. A door comprising:
a first skin;
a second skin;
a frame that is disposed between the first skin and the second skin;
a core that is disposed within the frame and between the first skin and the second skin in a thickness direction of the door, the core spanning across the door between the first and second skins, the core including a corrugated medium that is fluted with fluting running back and forth in the thickness direction between the first skin and the second skin as the corrugated medium spans between the first and second skins;
a compressed section where at least one of the first skin and the second skin is compressed into the core toward the other of the first skin and the second skin in the thickness direction;
the core including a plurality of walls, one of the plurality of walls including the corrugated medium that is supported by at least one linerboard, and another of the plurality of walls including another corrugated medium that is fluted with fluting running back and forth in the thickness direction between the first skin and the second skin, the other corrugated medium supported by another linerboard; and
the corrugated medium and the other corrugated medium have different periodicity.
